(19) United States
(12) Patent Application Publication
(10) Pub. No.: US 2012/0261227 A1
(43) Pub. Date: Oct. 18, 2012

(54) Clutch-Release Bearing Device including a Wear Ring

(75) Inventor: Benoit Arnault, Saint Cyr Sur Loire (FR)

(73) Assignee: AKTIEBOLAGET SKF, Goteborg (SE)

(21) Appl. No.: 13/157,056

(22) Filed: Jun. 9, 2011

(30) Foreign Application Priority Data
Jun. 9, 2010 (FR) 1054546

(51) Int. Cl. F16D 19/00; F16C 25/00

(52) U.S. Cl. 192/82 R; 192/110 B

(57) ABSTRACT

A rolling-contact bearing device has a central axis and includes a non-rotating ring, a rotating ring having an axial guide portion providing a raceway for rolling elements, a reinforcement portion extending radially from the guide portion, and a mounting portion disposed generally against the reinforcement portion such that the two portions form a fold providing a double thickness of material, the reinforcement and mounting portions extending obliquely with respect to the central axis, and at least one row of rolling elements disposed between the non-rotating and rotating rings. A wear ring is mounted on the mounting portion of the rotating ring, contactable with the clutch mechanism diaphragm, and is dimensioned such that a force applied through the wear ring to the mounting portion of the rotating ring is oriented toward the guide portion.

### CROSS-REFERENCE TO RELATED APPLICATIONS

This application claims priority to French patent application no. FR 1054546, filed on Jun. 9, 2010, which is incorporated fully herein by reference.

### BACKGROUND OF THE INVENTION

The present invention relates to the field of clutch-release bearing devices intended to act on the diaphragm of a clutch, in particular for a motor vehicle.

Clutch-release bearing devices typically include a rolling-contact bearing, one of the rings of which is a rotating ring and the other is a fixed ring, the rotating ring being provided with a radial leading surface which is intended to come into contact with the end of the fingers that make up the diaphragm of the clutch. A plurality of rolling elements are disposed between the rotating ring and the fixed ring and are evenly distributed in the circumferential direction by means of a cage.

A non-rotating operating element supports the rolling-contact bearing and, under the action of a (mechanical, electrical or hydraulic) control member, moves the rolling-contact thrust bearing axially in order to press the leading surface of the rotating ring against the clutch diaphragm and to actuate the clutch mechanism or system.

In order to limit wear by friction between the fingers of the diaphragm and the leading surface of the rotating ring during clutch-release and clutch-engagement operations, it is possible to provide a wear ring made of plastic on the leading surface. For more details, reference could be made, for example, to documents US-A1-2006/0081439 and U.S. Pat. No. 6,684,997.

During clutch-engagement operations, the rotating ring of the rolling-contact bearing is subjected to significant axial stresses of the clutch mechanism diaphragm. Over time, the repetition of these stresses may cause flexing of the rotating ring, the appearance of cracks, or even the breakage of the ring.

### SUMMARY OF THE INVENTION

The present invention aims to overcome these drawbacks, particularly by providing an economical and robust clutch-release bearing device which is able to withstand the axial loads exerted by the clutch mechanism diaphragm and has a limited axial space requirement.

In aspect, the present invention is a clutch-release bearing device for a clutch mechanism, the clutch mechanism including a diaphragm. The bearing device comprises a rolling-contact bearing having a central axis and including a non-rotating ring, a rotating ring having a generally axially-extending guide portion providing a raceway for rolling elements, a reinforcement portion extending generally radially from the guide portion, and a mounting portion disposed generally against the reinforcement portion such that the reinforcement and mounting portions form a fold providing a double thickness of material, the reinforcement and mounting portions extending generally obliquely with respect to the central axis. At least one row of rolling elements is disposed between the non-rotating and rotating rings. Further, a wear ring is mounted on the mounting portion of the rotating ring and is contactable with the clutch mechanism diaphragm. The wear ring is dimensioned such that a force applied through the wear ring to the mounting portion of the rotating ring is oriented generally toward the guide portion. The rotating ring is preferably of one-piece construction, such as for example, by being formed in a stamping process.

With the above-described structure, the mechanical strength of the rotating ring is increased in the contact region of the wear ring, thereby making it possible to obtain, with a reduced axial space requirement, better resistance to the axial loads exerted by the clutch mechanism diaphragm during clutch-engagement operations. The flexing of the rotating ring and the risk of cracks appearing over time are limited.

The mounting portion of the rotating ring with which the wear ring comes into direct contact is interposed axially between the wear ring and the reinforcement portion. The reinforcement portion limits the flexing of the mounting portion under loads applied by the clutch mechanism diaphragm. The structure of the rotating ring having double walls which rest against one another in the region of contact with the wear ring makes it possible to stiffen the rotating ring and to avoid its deterioration.

In one embodiment, the wear ring is angularly displaceable with respect to the mounting portion of the rotating ring, such that the axis of the wear ring is positionable, i.e., can be “tilted”, at an angle with respect to the rotational axis of the rolling-contact bearing. The wear ring can thus adapt to the angular misalignment between the rotational axes of the rolling-contact bearing and the associated clutch mechanism diaphragm.

Preferably, the guide portion has opposing radial sides, the reinforcement projects generally radially away from one side and the mounting portion extends from the reinforcement portion and projects generally radially away from the other side of the guide portion.

As used herein, the expressions “from which the portion extends” or “the portion extends from” is understood to mean a portion which extends directly from the other portion in question or a portion extending indirectly from the portion in question via one or more intermediate portions.

In one embodiment, the mounting portion and the reinforcement portion extend obliquely in a manner approximately parallel to one another. The mounting portion may extend in the direction of the non-rotating ring.

In one embodiment, the rotating ring is of one-piece construction and preferably formed of steel by means of a stamping process. The rotating ring is preferably the inner ring, but may alternatively be the outer ring.

In one embodiment, the wear ring comprises retaining means that are able to engage with the rotating ring in order to axially retain the wear ring in relation to the rotating ring. The wear ring itself comprises the means provided for engaging with the rotating ring in order to axially retain the wear ring with respect to the rolling-contact bearing. The wear ring is able to come into direct contact with a clutch mechanism diaphragm. The clutch-release bearing device forms a unitary assembly that can be stored, transported and mounted with a particularly low risk of the elements of which it is made accidentally coming apart.

In one embodiment, the wear ring has a body made of plastic and a stiffening insert for stiffening the body. Alternatively, the wear ring may have no such insert.

The invention also relates to a clutch control system comprising a control fork, a clutch mechanism diaphragm and a clutch-release bearing device as defined hereinabove and in further detail below.

### BRIEF DESCRIPTION OF THE SEVERAL VIEWS OF THE DRAWINGS

The present invention will be better understood from studying the detailed description of certain embodiments taken by way of non-limiting example and illustrated in the appended drawings, in which:

FIGS. 1 and 2 are views in axial section of a clutch-release bearing device according to a first embodiment of the invention, in the free state and the mounted state;

FIG. 3 is a detail view of FIG. 2;

FIG. 4 is a perspective view of the inner ring of the device from FIGS. 1 to 3;

FIGS. 5 and 6 are views in axial section of a clutch-release bearing device according to second and third embodiments of the invention, in the free state; and

FIG. 7 is a view in axial section of a clutch-release bearing device according to a fourth embodiment of the invention, in the mounted state.

### DETAILED DESCRIPTION OF THE INVENTION

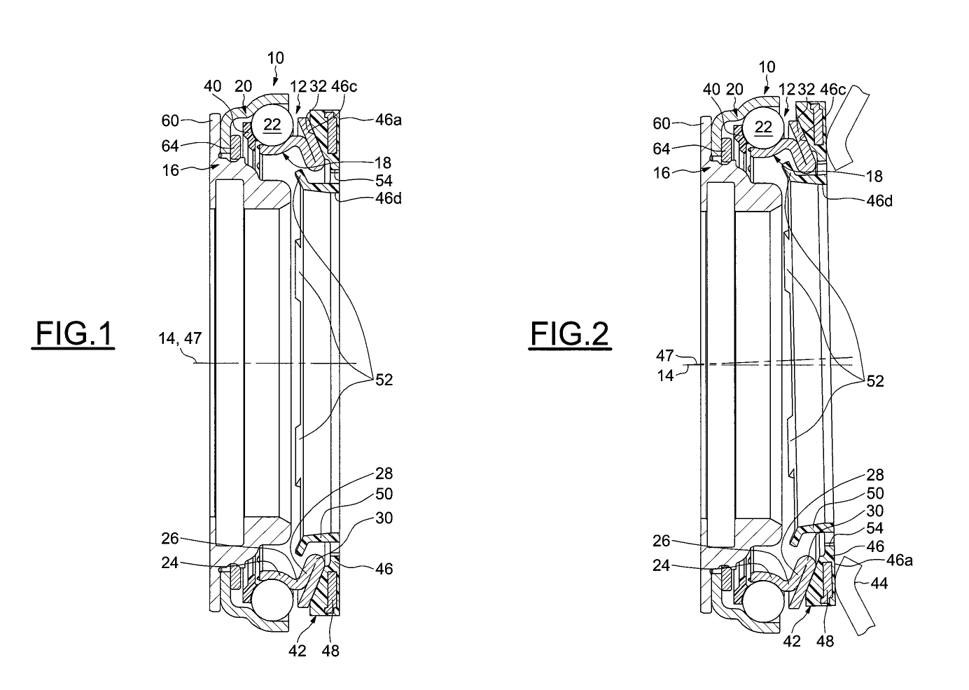

In FIGS. 1 to 4, a clutch-release bearing device 10 basically comprises a rolling-contact bearing 12 and a wear ring 42. The bearing 12 has a rotational axis 14 and is mounted on an operating element 16, which may be a component separate from the control member that actuates the device or may be an integral part thereof.

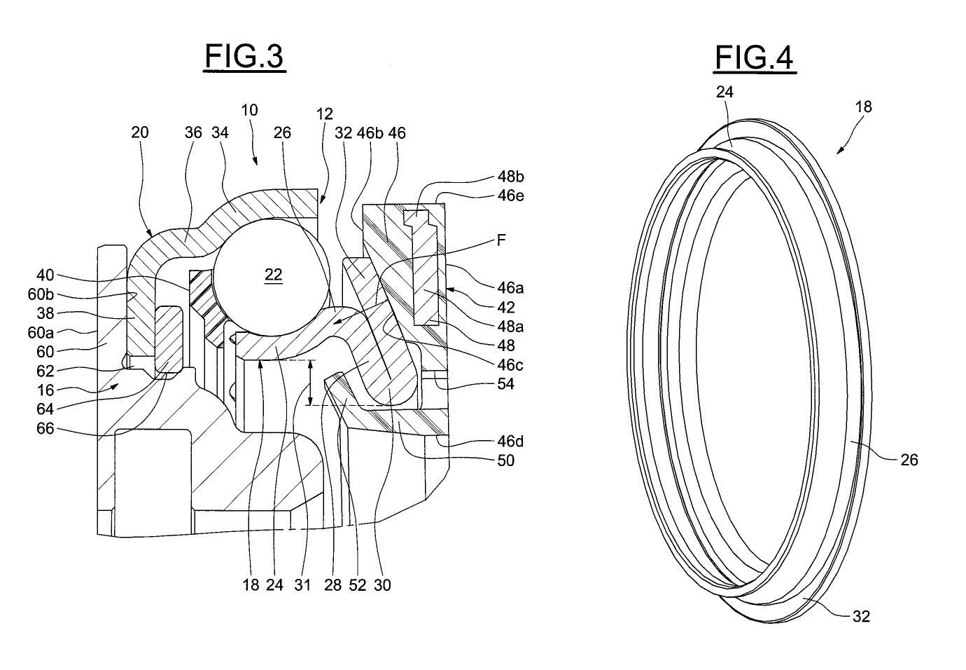

More specifically, the rolling-contact bearing 12 has an inner, rotating ring 18, an outer, non-rotating ring 20, and at least one row of rolling elements 22, preferably ball elements, disposed between the non-rotating and rotating rings 18, 20. The inner, rotating ring 18 is preferably generally thin-walled and produced of one-piece construction, most preferably by means of a stamping operation performed on a steel sheet or tube. The rotating ring 18 has a toroidal, generally axially-extending guide portion 24 having, in cross section, a concave internal profile in the form of a quarter circle, and provides a raceway for the rolling elements 22. The inner ring 18 also has a short, annular axial portion 26 that prolongs or extends from a large-diameter edge of the toroidal portion 24 axially opposite the outer, non-rotating ring 20, the annular portin 26 being prolonged or extended radially inwardly by an annular oblique reinforcement portion 28. The reinforcement portion 28 extends generally axially on the opposite side to the toroidal guide portion 24 and the rolling elements 22. The oblique reinforcement portion 28 extends generally radially inwardly from the axial portion 26 and axially opposite the toroidal portion 24. The reinforcement portion 28 has a small-diameter inside edge prolonged or extended by a rounded portion 30 over approximately 180°. The inside diameter of the rounded portion 30 is less than the inside diameter of the toroidal guide portion 24. In other words, the small-diameter inside edge of the rounded portion 30 is offset radially inwards with respect to the toroidal portion 24 and the axial portion 26. The radial distance between the inside diameter of the toroidal portion 24 and that of the rounded portion 30 is illustrated by the arrow bearing the reference 31 (FIG. 3).

The inner, rotating ring 18 also has an annular oblique mounting portion 32 prolonging or extending from the rounded portion 30 and which extends generally radially outwardly in the direction of the outer, non-rotating ring 20 and is disposed generally against the oblique reinforcement portion 28. Thus, the rounded portion 30 connects the two oblique portions 28, 32. The reinforcement and mounting portions 28, 32 extend generally obliquely with respect to the central axis 14 and are inclined with respect to a radial plane. The oblique mounting portion 32 is disposed generally against the oblique reinforcement portion 28 such that the reinforcement and mounting portions 28, 32 form a fold providing locally a double thickness of material. The oblique mounting portion 32 extends radially beyond the axial portion 26 on the opposite side to the oblique reinforcement portion 28. The large-diameter, peripheral outside edge of the oblique portion mounting 32 is offset radially outwards with respect to the toroidal guide portion 24 and the axial portion 26. In the embodiment illustrated, the oblique portion 32 extends radially beyond the center of the rolling elements 22. The inner surface of the oblique portion 32 rests against the outer surface of the oblique portion 28. The outer surface of the oblique portion 32 is convex and defines a spherical portion, the center of which coincides with the axis 14 of the rolling-contact bearing and is offset axially towards the outside with respect to the outer ring 20.

The outer, non-rotating ring 20 is also preferably generally thin-walled and may also be formed of one-piece construction, e.g., by stamping a steel sheet or tube. The non-rotating ring 20 has a toroidal portion 34 having in cross section a concave internal profile in the form of a quarter circle, which provides a raceway for the rolling elements 22. The toroidal portion 34 is prolonged or extended axially on the opposite side to the inner ring 18 by an annular axial portion 36. Axially on the opposite side to the toroidal portion 34, the axial portion 36 is prolonged radially inwardly by an annular radial portion 38.

The rolling-contact bearing 12 also has a retaining cage 40 for circumferentially spacing the rolling elements 22, the retaining cage 40 being located radially between the toroidal portion 24 of the inner ring 18 and the axial portion 36 of the outer ring 20. The retaining cage 40 is mounted axially between the rolling elements 22 and the radial portion 38 of the outer ring 20 and is located axially opposite the oblique portions 28, 32 of the inner ring 18 when considering the rolling elements 22.

The thrust ring or wear ring 42 is preferably disposed against the outer surface of the oblique mounting portion 32 of the rotating ring 18 and is contactable with a diaphragm 44 of a clutch mechanism in order to actuate the clutch mechanism or system. The wear ring 42 is mounted against the oblique mounting portion 32 axially on the opposite side to the oblique reinforcement portion 28 of the inner, rotating ring 18.

The wear ring 42 has an annular body 46 with an axis 47 and a stiffening insert 48 fixed to the body 46. In the embodiment illustrated, the body 46 is overmolded on the insert 48 and is produced from a polymeric material such as a plastic, for example unfilled, mineral fiber-filled or carbon-filled polyamide. The stiffening insert 48 is produced from a material that is more rigid than that of the body 46, for example, formed of metal or a rigid plastic.

The body 46 of the wear ring has an annular radial surface 46a, which is provided to engage by direct contact with the diaphragm 44, and an opposite annular radial surface 46b, the small-diameter edge of which is prolonged or extended by a concave surface 46c which has a matching shape and is in contact with the convex outer surface of the oblique portion 32 of the inner ring 18. During the mounting of the wear ring 42 on the inner, rotating ring 18, the oblique mounting portion 32 generally centers the body 46 on the ring 18.

The wear ring body 46 also has an axial bore 46d, the diameter of which is less than the diameter of the rounded portion 30 of the inner ring 18, and a cylindrical outer surface 46e. The body 46 further has an annular axial portion 50 prolonging the bore 46d axially next to the inner ring 18. The axial end of the axial portion 50 is prolonged or extended by at least one projection, preferably in the form of tongues 52 extending obliquely towards the outside in the direction of the inner ring 18. Preferably, the body 46 has six tongues 52 spaced circumferentially and generally evenly apart about the axis 47, which may have, for example, a circumferential dimension of between 10 and 30 degrees. The tongues 52 are located generally axially between the toroidal guide portion 24 and the oblique reinforcement portion 28 of the inner ring and have an outside diameter greater than the inside diameter of the rounded portion 30 of the inner ring 18. As such, the wear ring 42 can be retained axially in relation to the inner ring 18 by diametric interference between the tongues 52 and the ring. The tongues 52 form hooks that are engageable with the inner ring 18 in order to secure these two elements axially such that the bearing device 10 forms a unitary assembly that can be handled, transported and mounted in a single operation.

As described above, in the embodiment illustrated, the wear ring body 46 is overmolded on the stiffening insert 48 in order to obtain the wear ring 42. In order to enable axial demolding of the wear ring 42 thus formed, in particular of the tongues 52, the body 46 has, axially opposite each tongue, a through-hole 54 formed axially near the bore 46d and having a circumferential dimension equal to that of the tongues.

The stiffening insert 48 is in the form of a substantially flat washer. In the embodiment illustrated, the insert 48 has an annular radial portion 48a located in the vicinity of the radial surface 46a of the body 46 and prolonged at a large-diameter edge by a radial flange 48b that is partially offset axially with respect to the radial portion 48a so as to increase the rigidity of the wear ring 42. The flange 48b is located in the vicinity of the outer surface 46e of the body 46. In the embodiment illustrated, the stiffening insert 48 is entirely embedded inside the body 46 of the wear ring. Alternatively, it is possible to provide an insert that is partially embedded inside the body. In another variant embodiment, it could also be possible to fix the body 46 to the stiffening insert 48 by any other appropriate means, for example by adhesive bonding. Alternatively, it is further possible to provide a wear ring that does not have a stiffening insert.

The operating element 16 may be produced from molded plastic, for example from polyamide, or else from metal. The operating element 16 is a component separate from a control fork (not shown), which fork is able to exert an axial force on the element in order to move the device 10 as a whole during a clutch-release operation. The operating element 16 has to this end a radial flange 60 provided with a contact surface 60a oriented towards the rear of the bearing device 10 and able to engage with the control fork. The flange 60 also has an opposite contact surface 60b which is oriented towards the front and is in frictional contact with the radial portion 38 of the outer ring 20. There is a radial clearance 62 between an approximately cylindrical outer surface of the operating element 16 and the small-diameter edge of the radial portion 38, such that a certain radial movement of the rolling-contact bearing 12 can take place with respect to the operating element 16 and the bearing can thus self-align in the radial direction.

A retaining washer 64 is mounted in a groove 66 made in the outer surface of the operating element so as to axially secure the operating element 16 to the rolling-contact bearing 12. The washer 64 comes to rest against the radial portion 38 of the outer ring 20 axially on the opposite side to the flange 60 of the operating element 16.

As illustrated in FIG. 1, in a neutral position of the device 10 before it is mounted on the clutch system diaphragm, the axis 47 of the wear ring 42 is coaxial with the axis 14 of the rolling-contact bearing 12.

When the device 10 is fitted on the diaphragm 44 with an axial preload, the wear ring 42 is adaptable to angular misalignments that exist between the axis 14 of the rolling-contact bearing and the axis of the diaphragm. Specifically, during contact between the diaphragm 44 and the front radial surface 46a of the wear ring 42, the ring can tilt at an angle with respect to the axis 14 such that its axis 47 is aligned with the axis of the diaphragm. In FIG. 2, the axis 47 of the wear ring 42 is angularly misaligned with respect to the axis 14 in the anticlockwise direction while remaining in a single radial plane. Of course, tilting of the wear ring 42 can also occur in the clockwise direction. The angular tilting of the axis 47 in relation to the axis 14 is for example less than 3 degrees, in particular around 2 degrees.

The “swiveling” capacity of the wear ring 42 in relation to the rotating inner ring 18, and more generally with respect to the rolling-contact bearing 12, allows the angular self-alignment of the axis 47 of the ring on the axis of the diaphragm and allows the axis to adapt in this way to the angular misalignment between the axis of the diaphragm and the axis 14.

The wear ring 42 is pivotable on the oblique portion 32 of the inner, rotating ring 18 while remaining in contact with the outer surface of the portion 32. The oblique mounting portion 32 thus performs the function of mounting and centering the wear ring 42 on the rotating ring 18 and the function of guiding the ring 42 when the ring 42 tilts when the device 10 is fitted on the diaphragm 44. The region in which the wear ring 42 can come to rest against the inner ring 18 extends at most from the inside edge of the rounded portion 30 to the outside edge of the oblique portion 32.

In the case of an inner ring which has no oblique portion 32 and for which the radial distance 31 is kept constant on account of dimensioning constraints to be respected, the region in which the wear ring 42 can come to rest extends at most from the inside edge of the oblique portion 28 to the outside edge of the axial portion 26.

With the inner, rotating ring 18 as illustrated having an oblique mounting portion 32 that extends in the radial direction beyond the axial portion 26, the surface of contact between the inner ring 18 and the wear ring 42 is thus increased in comparison to a ring formed without such an oblique portion 32, thereby allowing better distribution of the axial loads exerted by the diaphragm 44. The risk of stresses being concentrated at the inner ring 18 is this limited.

Moreover, with an oblique mounting portion 32 extending radially beyond the axial portion 26, the dimension of the contact surface 46c of the wear ring 42 is preferably selected such that a force F applied through the ring 42 to the oblique mounting portion 32 is oriented generally obliquely toward the toroidal guide portion 24, specifically in the vicinity of the surface of contact between the rolling elements 22 and the guide portion 24. Such an arrangement promotes good transmission of the applied force F by the rolling-contact bearing 12.

The region of contact between the diaphragm 44 and the radial surface 46a of the wear ring 42 can also be increased by virtue of the dimensioning of the oblique mounting portion 32 of the inner, rotating ring 18.

Furthermore, the oblique reinforcement portion 28, against which the oblique mounting portion 32 is disposed, axially on the opposite side to the wear ring 42, mechanically stiffens the inner ring 18 with regard to the forces exerted by the diaphragm 44. The oblique mounting portion 32 is folded over against the oblique portion 28 so as to form on the inner ring 18 a fold providing a double thickness of material with respect to the rest of the thickness of the ring 18. In the region of contact between the wear ring 42 and the inner, rotating ring 18, the mechanical structure of the inner ring 18 is reinforced to increase absorption of a force F applied by the wear ring 42.

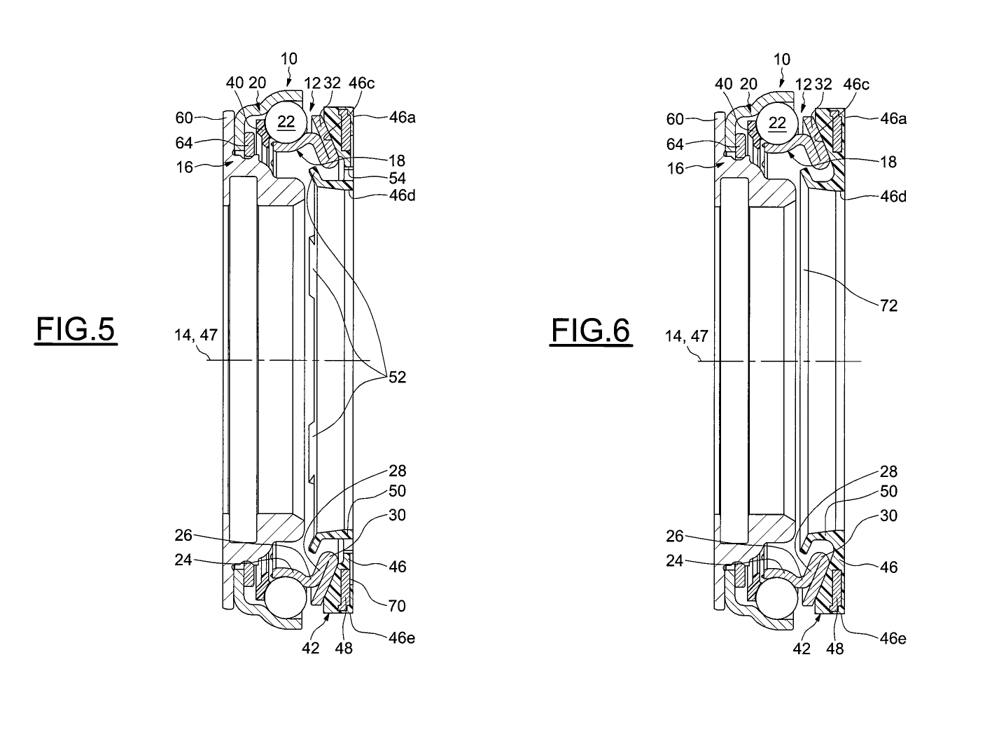

The embodiment illustrated in FIG. 5, in which the identical elements have the same references, differs from the embodiment described hereinabove in that the wear ring 42 has recesses 70 made starting from the radial surface 46a and extending axially as far as a small-diameter edge of the radial portion 48a of the stiffening insert 48. There are four recesses 70, which have a generally circular shape and are spaced apart from one another evenly in the circumferential direction. They are located radially between the outer surface 46e and the openings 54, in the vicinity of the openings. The recesses 70 result from keeping the stiffening insert 48 in position during the overmoulding of the body 46 of the wear ring.

The variant embodiment illustrated in FIG. 6, in which the identical elements have the same references, differs from the first embodiment described in that the wear ring 42 has an annular rim or flange 72, replacing the tongues 52 spaced apart in the circumferential direction. The orientation of the flange 72 is identical to that of the tongues 52. The flange 72, which prolongs the axial portion 50 obliquely towards the outside, is able to engage with the rounded portion 30 of the inner ring 18 by diametric interference in order for the wear ring 42 to be retained axially in relation to the inner ring. In this embodiment, the wear ring 42 does not have the openings 54 illustrated in the embodiment of FIGS. 1 to 4, the ring being demolded by virtue of sliders.

In all of the embodiments illustrated, the wear ring 42 includes a retaining portion engageable with the rounded portion 30 of the inner, rotating ring 18 connecting the oblique portions 28, 32 in order to axially retain the wear ring 42 on the rolling-contact bearing 12. As a variant, it could also be possible to provide a means for retaining the wear ring 42 that engage with a different portion of the rotating inner ring 18, for example the oblique portion 28 or the peripheral edge of the oblique portion 32.

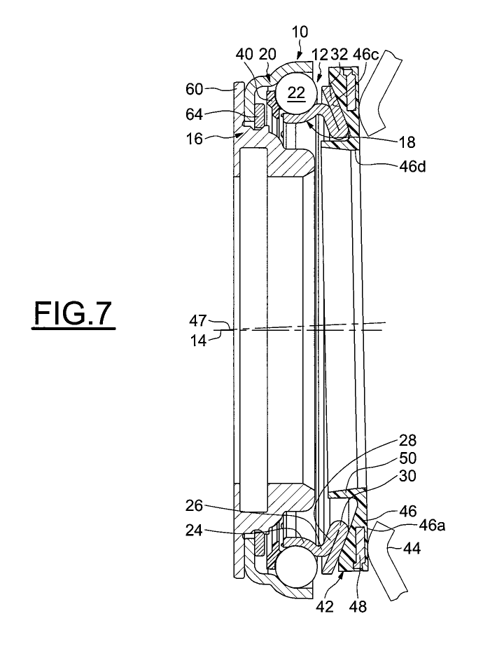

Alternatively, it could also be possible to provide a wear ring that does not have any means for axially retaining the ring on the inner ring of the rolling-contact bearing, as is illustrated in the embodiment of FIG. 7 in which the identical elements have the same references.

In all of the embodiments illustrated, the inclined reinforcement and mounting portions 28, 32 extend obliquely while being approximately parallel to one another. Alternatively, it could be possible to provide a different design of the inner ring 18 by providing portions 28, 32 that extend substantially radially.

In the embodiments illustrated, the outer ring 20 is a non-rotating ring and the inner ring 18 is a rotating ring. Alternatively, it could also be possible to provide a non-rotating inner ring and a rotating outer ring.

The invention provides a clutch-release bearing device in which that rotating ring of the rolling-contact bearing that engages with the wear ring has increased mechanical strength without it being necessary to provide an additional component inserted between these two elements. The rotating ring can be mass produced at low cost for example by cutting and pressing steel, in particular a sheet metal blank.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

I claim:

1. A clutch-release bearing device for a clutch mechanism, the clutch mechanism including a diaphragm, the bearing device comprising:
a rolling-contact bearing having a central axis and including a non-rotating ring, a rotating ring having a generally axially-extending guide portion providing a raceway for rolling elements, a reinforcement portion extending generally radially from the guide portion, and a mounting portion disposed generally against the reinforcement portion such that the reinforcement and mounting portions form a fold providing a double thickness of material, the reinforcement and mounting portions extending generally obliquely with respect to the central axis, and at least one row of rolling elements disposed between the non-rotating and rotating rings; and
a wear ring mounted on the mounting portion of the rotating ring, contactable with the clutch mechanism diaphragm, and being dimensioned such that a force applied through the wear ring to the mounting portion of the rotating ring is oriented generally toward the guide portion.

2. The bearing device as recited in claim 1 wherein the rotating ring is of one-piece construction.

3. The bearing device according to claim 1 wherein the wear ring has a central axis and is angularly displaceable with respect to the mounting portion of the rotating ring such that the axis of the wear ring is positionable at an angle with respect to the axis of the rolling-contact bearing.

4. The bearing device according to claim 1 wherein the guide portion of the rotating ring has opposing radial sides, the reinforcement portion projects generally radially away from one side of the guide portion, and the mounting portion extends from the reinforcement portion and projects radially away from the other side of the guide portion.

5. The bearing device according to claim 1 wherein the mounting portion and the reinforcement portion extend generally parallel to each other.

6. The bearing device according to claim 1 wherein the mounting portion extends generally toward the non-rotating ring.

7. The bearing device according to claim 1, wherein the rotating ring is formed in a stamping process.

8. The bearing device according to claim 1 wherein the rotating ring is disposed radially inwardly of the non-rotating ring.

9. The bearing device according to claim 1, wherein the wear ring includes a retaining portion engageable with the rotating ring so as to axially retain the wear ring in relation to the rotating ring.

10. A clutch control system comprising:
a control fork;
a clutch mechanism diaphragm; and
a clutch-release bearing device including:
a rolling-contact bearing having a central axis and including a non-rotating ring, a rotating ring having a generally axially-extending guide portion providing a raceway for rolling elements, a reinforcement portion extending generally radially from the guide portion, and a mounting portion disposed generally against the reinforcement portion such that the reinforcement and mounting portions form a fold providing a double thickness of material, the reinforcement and mounting portions extending generally obliquely with respect to the central axis, and at least one row of rolling elements disposed between the non-rotating and rotating rings; and
a wear ring mounted on the mounting portion of the rotating ring, contactable with the clutch mechanism diaphragm, and being dimensioned such that a force applied through the wear ring to the mounting portion of the rotating ring is oriented generally toward the guide portion.
